(19) United States
(12) Patent Application Publication
(10) Pub. No.: US 2010/0258775 A1
(43) Pub. Date: Oct. 14, 2010

(54) Automatic Rising Jack Stand

(75) Inventor: Gong Zhengwei, Zhejiang (CN)

Correspondence Address: LATHROP & GAGE LLP, 2345 GRAND Boulevard, SUITE 2400, KANSAS CITY, MO, 64108, US

(73) Assignees: Shinn Fu Company of America, Inc., Kansas City, MO (US); Hangshou TianHeng Machine Co., Ltd., Hangzhou (CN)

(21) Appl. No.: 12/722,090

(22) Filed: Mar. 11, 2010

Related U.S. Application Data
(60) Provisional application No. 61/159,863, filed on Mar. 13, 2009.

(51) Int. Cl. B66F 3/42; B66F 1/04

(52) U.S. Cl. 254/93 H; 254/112

(57) ABSTRACT

Jack stands having support arms that automatically rise to meet lifted loads are disclosed herein. According to one embodiment, a jack stand includes a base having a collar, a support arm, a locking mechanism, and a lifting mechanism. The support arm is movable within the collar and has a plurality of teeth defining grooves and ridges. The locking mechanism has a handle and a stopper and is rotatably coupled to the base at an axis of rotation for movement between a first position where the stopper engages at least one of the grooves to restrict the support arm from moving downwardly, and a second position where the support arm is movable upwardly and downwardly. The lifting mechanism is coupled to the base and is in communication with the support arm to automatically raise the support arm relative to the collar when the locking mechanism is moved to the second position.

### RELATED APPLICATIONS

This application claims priority to U.S. Provisional Patent Application Ser. No. 61/159,863, filed Mar. 13, 2009, the disclosure of which is incorporated herein by reference.

### TECHNICAL FIELD

The present disclosed subject mater is related to jack stands used in supporting raised loads after the load has been jacked or lifted. In particular, the present disclosed subject matter is directed to jack stands that automatically raise the support arm, for example, a ratchet bar, into contact with the lifted load.

### BACKGROUND

Jack stands typically are employed for supporting a jacked or lifted load, such as a vehicle, safely and securely. For example, after a load has been jacked or lifted, one or more jack stands, typically paired jack stands to evenly support the load, are placed under the load to securely support the load in the lifted position. With the jack stands supporting the load, the lifting jack is removed; the jack stands replace the lifting jack as the support for the lifted load.

One type of conventional jack stands has a base with a tubular collar for maintaining a column of a support arm. The support arm is formed of the column having an end terminating in a saddle, with a dimension larger than the collar and of a shape to support the lifted load, which it contacts. The column is movable in the collar to adjustable heights, for example, to the height of the contact with the lifted load. A portion of the column remains in the collar of the base, so that the height of the column is fixed by one or more pins that extend through aligned openings in the collar and the column.

Another type of conventional jack stand 20 is shown in FIGS. 1A-1C. The jack stand 20 has a base 22 that includes a support 24 and a collar 26. The collar 26 supports a vertically adjustable support arm 27, for example a ratchet bar 28 terminating in a saddle 29. The ratchet bar 28 is movable within the collar 26, between guide walls of the collar 26. Teeth 30 extend along one side 28a of the ratchet bar 28, while the opposite side 28b of the ratchet bar 28 is flat or smooth. The collar 26 includes an opening 31 defined by edges 31 a through which the ratchet bar 28 extends. The saddle 29 has a larger dimension than the opening 31. The saddle 29 is shaped to contact and engage a load, such as an automobile, other motor vehicle, or the like.

A ratchet mechanism in the collar 26 includes a pawl 32 connected to a handle 36 for moving the pawl 32. The pawl 32 has a single engagement component 32a that engages between teeth 30 on the toothed side 28a of the ratchet bar 28. The handle 36 limits the range of movement by the pawl 32 since movement of the handle 36 is limited by its ultimate abutment with the collar 26.

When lifting the ratchet bar 28 is desired, the handle 36 is moved, typically upward, so as to move the pawl 32 and its engagement component 32a upward and out of engagement with the teeth 30. The ratchet bar 28 then is moved upward manually. Once the desired height is reached, the pawl 32 is moved back into engagement with the teeth 30 on the ratchet bar 28 by the handle 36 being moved downward, either controlled or in a free fall.

These conventional jack stands exhibit drawbacks, in that they require the user to be in two-handed contact with them during their placement and locking under the load. As a result, the user is under the load during the entire jack stand placement operation, subjecting him to danger of a collapse while under the load. Additionally, the required two-handed contact requires coordination and skill by the user to attain the proper positioning of the support arm and secure locking thereof in the collar.

### SUMMARY

The present disclosed subject matter provides a jack stand including a support arm that automatically rises to the level of the lifted load. The disclosed jack stand is such that it minimizes the time the user must be under the load, and requires only one hand to operate.

The disclosed jack stand includes a spring-biased handle, movable from an initial position to a disengaged position, where the handle structure is out of contact with the paired ratchet teeth of the support arm. This allows the ratchet bar to be forced upward by a lift mechanism or cylinder (e.g., a pneumatic cylinder) until the saddle of the support arm contacts the lifted load. Once the contact is made, the handle returns to a position, as biasing means (e.g., spring biasing, gravity biasing, etc.) cause it to contact the ratchet bar, where it engages a pair of ratchet teeth. This engagement locks the ratchet bar place, and the load is held securely.

An embodiment is directed to a jack stand that includes a base with a collar and a support arm movable within the collar. There is a holding mechanism for moving between a first position, where the support arm is held in an engaged position, and a second position, where the holding mechanism is disengaged from the support arm, such that the support arm is movable. There is also a lifting mechanism (e.g., a pneumatic cylinder for driving a ram) that in turn moves the support arm automatically into contact with a load when the holding mechanism is in the second position, disengaged from the support arm.

### BRIEF DESCRIPTION OF THE DRAWINGS

Attention is now directed to the drawings, where like reference numerals and/or characters indicate corresponding or like components. In the drawings:

FIGS. 1A and 1B are perspective views of a conventional jack stand;

FIG. 1C is a cross sectional view of the conventional jack stand taken along line 1C-1C of FIG. 1A;

FIG. 2A is a perspective view of a jack stand in accordance with the present disclosure;

FIG. 2B is a cross-sectional view of the jack stand of FIG. 2A, taken along line 2-2;

FIG. 2C is a cross-sectional view of the handle of the jack stand of FIG. 2A, taken along line 2-2; and,

FIGS. 3A-3D are cross-sectional views of the jack stand of FIG. 2 in an exemplary operation, taken along line 2-2.

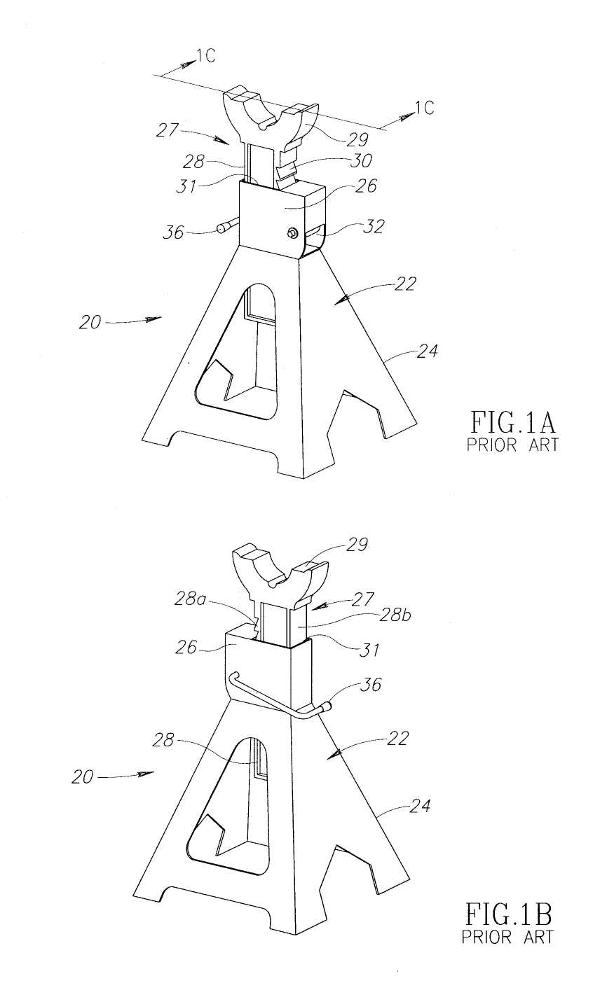

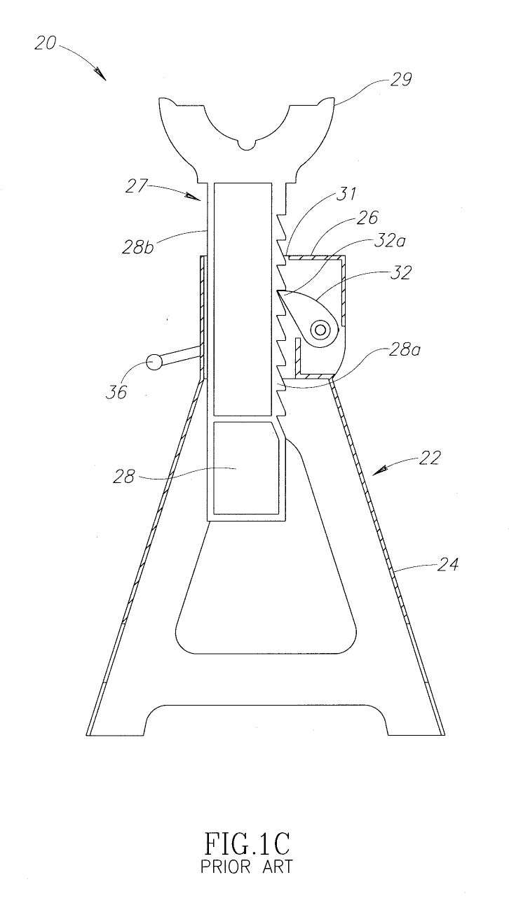

### DETAILED DESCRIPTION

In this document, references are made herein to directions such as up, down, upward, downward, upper, lower, inward, outward, all variations thereof, and the like. These references are exemplary only in order to describe the disclosed apparatus in a typical orientation or operation and are not independently limiting.

Additionally, the term “ratchet” is used herein. A ratchet is a device, structure, mechanism, part of a machine, or the like, which effects movement in at least one direction, as will be appreciated by those skilled in the art.

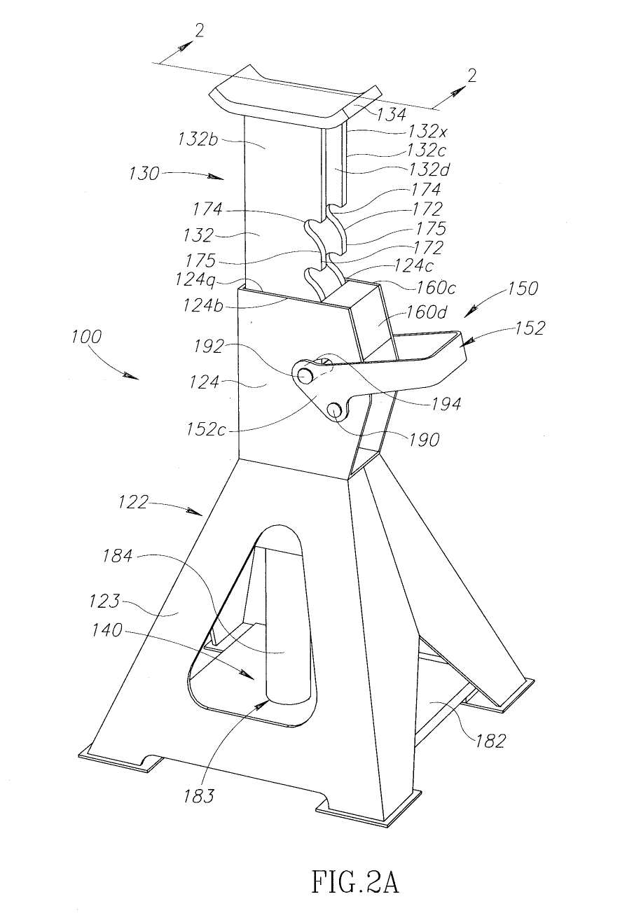

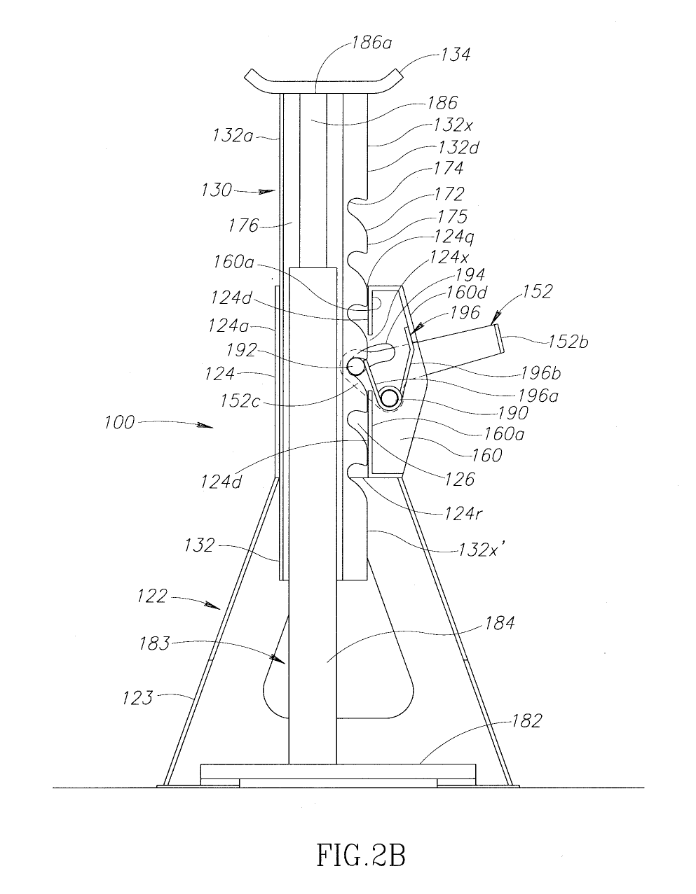

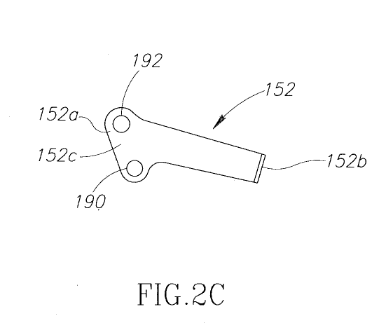

FIGS. 2A-2C show the jack stand 100 of the disclosed subject matter according to an embodiment. The jack stand 100 includes a base or frame 122 that includes a support 123 and a collar 124. A bore 126 extends through the collar 124. A support arm 130 is formed of a ratchet bar 132 and a saddle 134, at the upper end of the ratchet bar 132. The support arm 130, and in particular, the ratchet bar 132 is movable or adjustable (e.g., vertically) in the collar 124 (i.e., in the bore 126). A lifting mechanism 140, mounted to the base 122 and connected to the ratchet bar 132, provides lifting force (e.g., upward movement) to the support arm 130. A handle mechanism 150, that includes a movable handle 152, controls engagement and disengagement of the ratchet bar 132, allowing for the lifting and retention of the support arm 130.

The base or frame 122, is, for example, shaped as a square or rectangular pyramid, so as to provide maximum stability to the jack stand 100. The base 122, collar 124 and support arm 130 are made of metal or any other appropriate material.

The collar 124 supports the adjustable ratchet bar 132, as walls 124a-124d horizontally confine the ratchet bar 132. The walls 124a-124d form upper 124q and lower 124r openings, through which the ratchet bar 132 extends. One wall 124d includes a lateral opening 124x through which components of the handle mechanism 150 (detailed below) interact with the ratchet bar 132 to control its movement. An extension portion 160 of the collar 124 houses components of the handle mechanism 150, such as discussed below.

The ratchet bar 132 includes paired and aligned teeth 172 (also referred to as ratchet teeth) extending along opposite lateral sides 132b, 132c of the ratchet bar 132. The teeth 172 may be of a variety of shapes, such as sawtooth, and include grooves 174 and ridges 175 that accommodate unidirectional movement, i.e., in the upward (vertical) direction only. The paired teeth 172 protrude from a single side 132d of the ratchet bar 132, while the opposite side 132a of the ratchet bar 132 is flat or smooth. The side 132d of the ratchet bar 132 also includes non-toothed portions 132x, 132x′, proximate to the upper and lower edges of the ratchet bar 132.

The ratchet bar 132 terminates in a saddle 134 at its upper end. The saddle 134 is of at least one dimension, such as a length, greater than the upper opening 124q of the collar 124, to serve as a travel limit for the ratchet bar 132. The saddle 134 is configured to contact a load. A hollow bore 176 extends through the ratchet bar 132 and is, for example, closed by the saddle 134.

The lifting mechanism 140 provides force to lift the support arm 130 without any user interaction with the support arm 130. In some embodiments, the lifting mechanism 140 includes a base plate 182 that supports a lift unit 183. The lift unit 183 may include a cylinder body 184, from which a movable ram 186 extends. The base plate 182 is attached to the base 122 (at the support 123) by mechanical fasteners (e.g., screws, bolts, etc.) or any other acceptable fastening technique (e.g., welds, adhesives, etc.). The cylinder body 184 and the ram 186 are positioned to sit within the bore 176 of the ratchet bar 132, such that the ratchet bar 132 is movable (e.g., vertically). The ram 186 at its end 186a may be attached to the saddle 134 (e.g., by mechanical fasteners, welds, adhesives, etc.) if such additional securement is desired.

Though other embodiments are clearly possible and contemplated herein (e.g., a spring-powered lift unit, an elastomer-powered lift unit, a hydraulic lift unit, a hybrid lift unit, etc.), it may be desirable for the lift unit 183 to be air driven, and to be, for example, an air bar or a pneumatic cylinder. The air bar or pneumatic cylinder may be such that it applies both upward force (i.e., toward the support arm 130), and downward force (i.e., toward the base 122), to push the support arm 130 and move it upward (e.g., vertically).

The handle mechanism 150 includes the handle 152, that is, for example, U-shaped, with an open end 152a and a closed end 152b, and oppositely disposed head portions 152c at the open end 152a, as shown in detail in FIG. 2C. The handle 152 is pivotally mounted to the collar 124 by a pin 190. A cross bar or stopper 192 extends across the open end 152a of the handle 152. The head portions 152c of the handle 152 are mounted on the outer sides 160x of the column extension portion 160, and both head portions 152c receive the pin 190 and the cross bar 192.

The extension portion 160 includes a front wall 160a that is common with the wall 124d of the collar 124, lateral walls and a rear wall 160d, that is, for example V-shaped. The lateral walls may include identically shaped and positioned cut outs 194, which the ends of the crossbar 192 extend through. The cut outs 194, are, for example, rounded, and serve as tracks for the respective ends of the crossbar 192, confining the movement of the crossbar 192, and accordingly limiting the movement of the handle 152. The cross bar 192 is of a diameter to seat within grooves 174 of the ratchet bar 132. The cross bar 192 is movable over a range of positions, from within the grooves 174 of the ratchet teeth 172, to out of contact with the ratchet teeth 172, and through the opening 124x in the wall 124d/160a to beyond the plane of the wall 124d/160a.

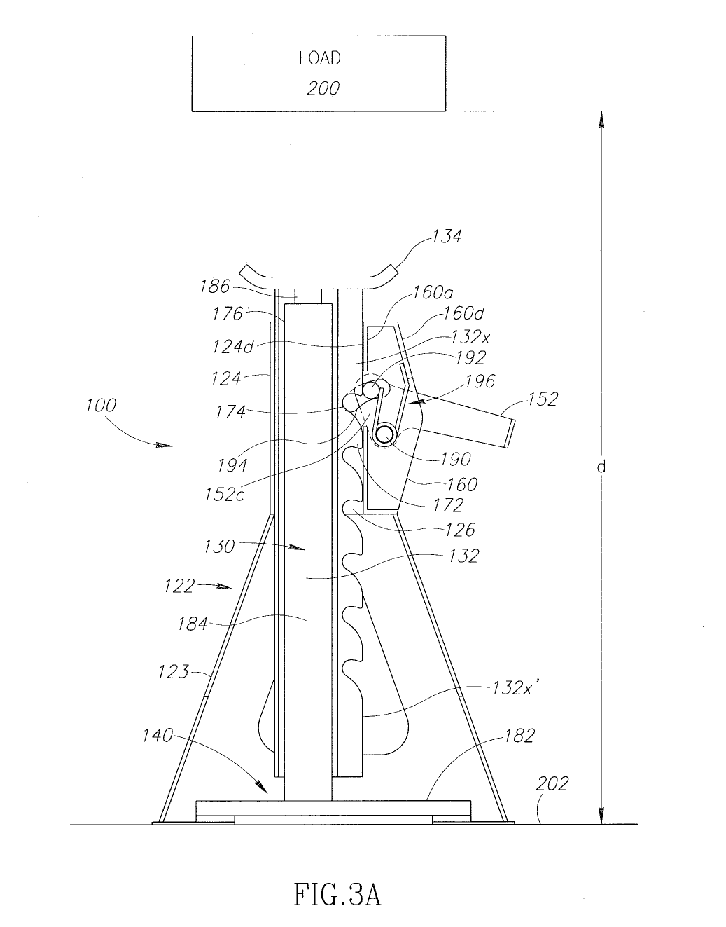

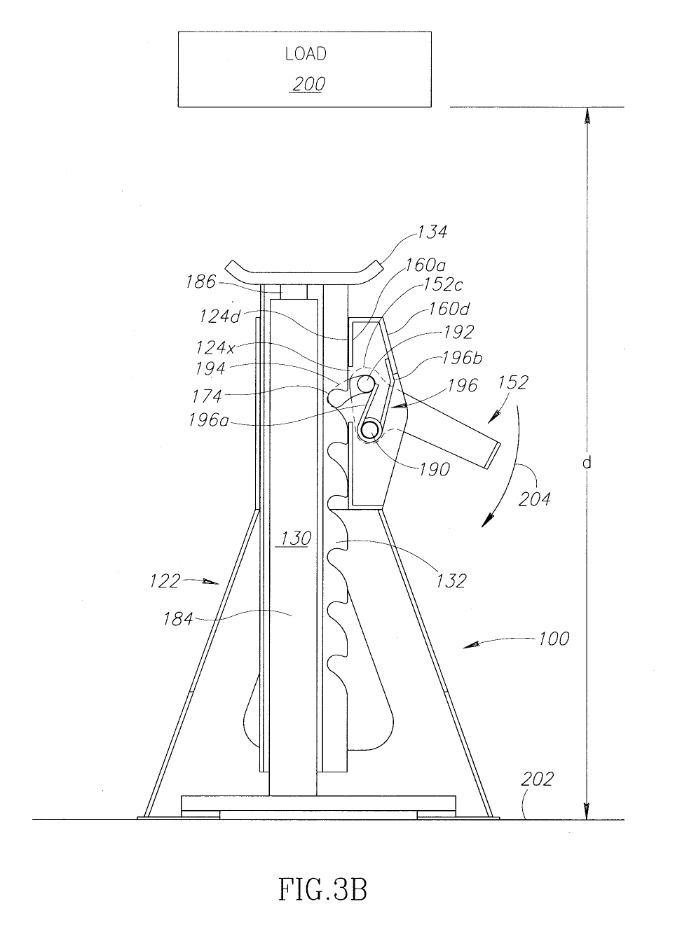

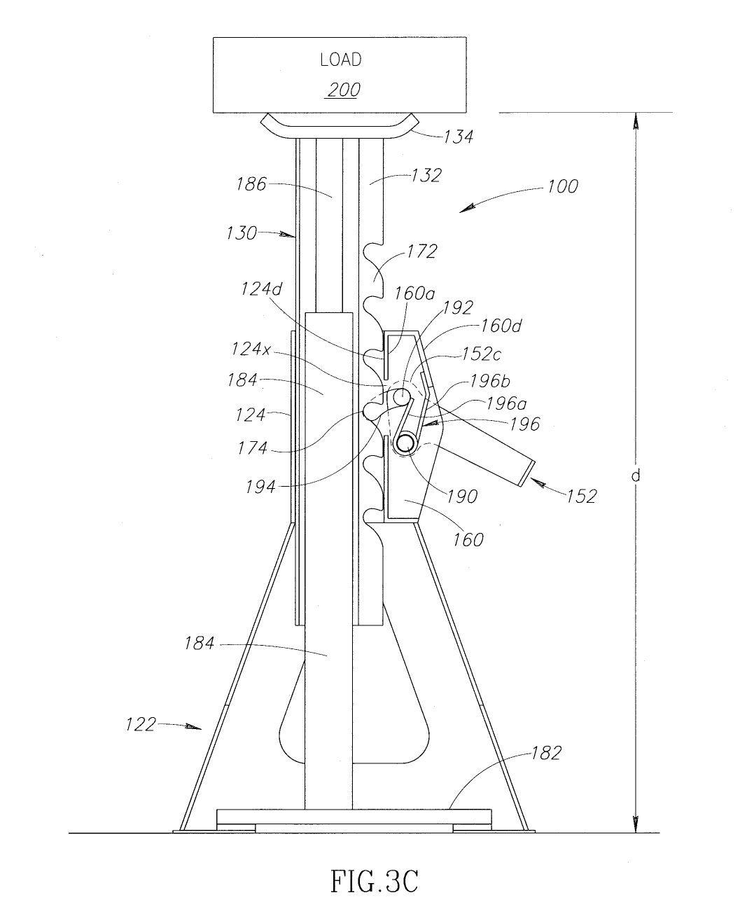

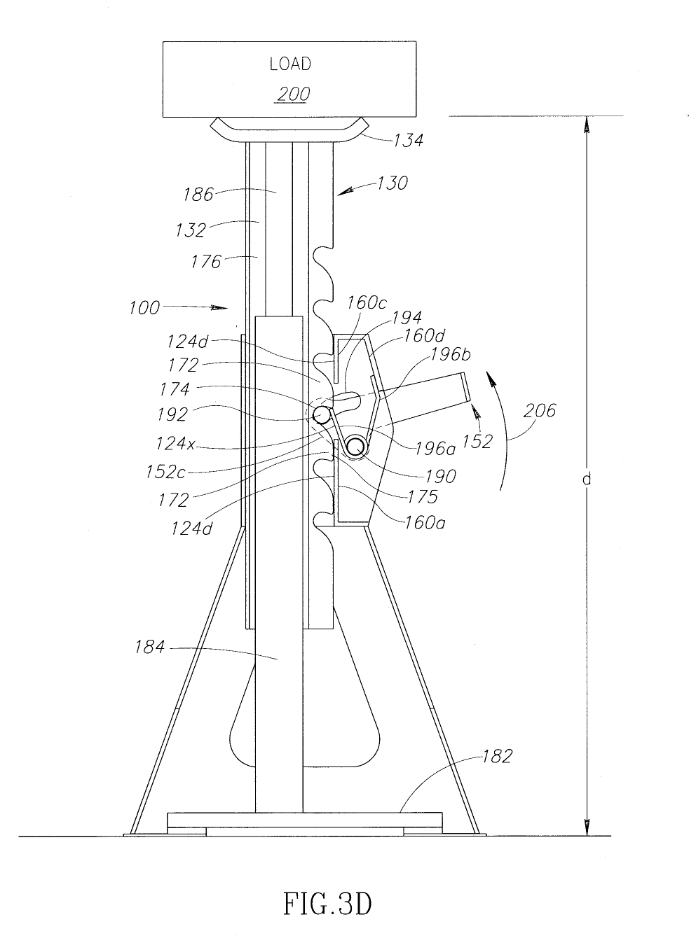

A spring 196, coiled around the pin 190, includes a straight arm 196a that presses against the cross-bar 192, and a bent arm 196b that contacts the rear wall 160d of the extension portion 160. In this arrangement, the spring 196 biases the handle 152 and the cross bar 192 inward (i.e., toward the ratchet bar 132), such that the cross bar 192 seats in corresponding grooves 174 (FIGS. 2B and 3D) or abuts the ratchet bar 132 (FIG. 3A) along the non-toothed portions 132x or 132x′. Alternately, the biasing formed by the spring 196 around the pin 190 may be replaced by gravity or weight biasing mechanisms. The handle 152 is movable with small amounts of manual force, such that once the cross bar 192 moves beyond the ratchet teeth 172), the lift unit 183 automatically moves the support arm 130 upward into contact with the lifted load. While the handle 152 is shown as requiring downward movement to separate the cross bar 192 from the ratchet teeth 172, those skilled in the art will appreciate that the handle 152 may alternately be configured such that upward movement of the handle 152 separates the cross bar 192 from the ratchet teeth 172. For example, the handle 152 may extend across the collar 124 instead of on one side of the collar 124 as shown.

Attention is now directed to FIGS. 3A-3D, in addition to FIGS. 2A-2C, detailing an example operation of the jack stand 100 with respect to a load 200 that has been lifted to an elevation “d” off of the ground 202. The load 200 may be, for example, an automobile or the like, having been lifted to the elevation “d” by a jack or the like.

FIG. 3A shows the jack stand 100 in a rest, initial, or storage position. In this position, the support arm 130 is at its lowest position and the saddle 134 may contact the opening 124q of the collar 124. The ratchet bar 132 is configured such that in this position of the support arm 130, the cross bar 192 abuts the non-toothed oppositely positioned straight portion 132x along the side 132d of the ratchet bar 132. The spring 196 (via the straight arm 196a with leverage from the bent arm 196b abutting the rear wall 160d) forces the cross bar 192 against the non-toothed oppositely positioned straight portions 132x, with a force greater than that of the force from the lift unit 183, holding the support arm 130 in place. The cross bar 192 is in the cut outs 194, intermediate the ends. The load 200 is positioned a distance “d” from the ground 202.

In FIG. 3B, the handle 152 is moved downward, as indicated by the arrow 204, such that the cross bar 192 disengages the ratchet bar 132, by moving out of contact with the teeth 172 of the ratchet bar 132. The continued downward movement of the handle 152 (in the direction of the arrow 204) moves the cross bar 192 beyond the plane of the wall 124d/160a until the cross bar 192 contacts the outer ends of the cut outs 194. The movement of the cross bar 192 compresses the spring 196. Upon the aforementioned disengagement, the force from the lift unit 183 instantly moves the ram 186, extending it out of the cylinder 184. The support arm 130 is forced upward, until the saddle 134 contacts the load 200, at the elevation “d”, as shown in FIG. 3C.

The handle 152 is typically released once brought to the position of FIG. 3C, and instantly moves upward, in the direction of the arrow 206, due to the biasing of the spring 196. As shown in FIG. 3D, the cross bar 192 then seats in corresponding grooves 174 of corresponding teeth 172 on the ratchet bar 132, resulting in a locking engagement, sufficient to support the load. In this position, the cross bar 192 abuts the inner ends of the cut outs 194, and the spring 196 has returned to a relaxed position. This locking engagement is maintained until the handle is moved in the direction of the arrow 204 and the support arm 130 is moved downward, such that the jack stand 100 returns to the initial or storage position of FIG. 3A.

Though not specifically shown in the accompanying drawings, those skilled in the art will appreciate that the support arm 130 and the collar 124, for example, may include corresponding holes, and that a pin may be removably placed through the holes as an additional safety mechanism to keep the support arm 130 from unintentionally raising or lowering.

While preferred embodiments have been described, so as to enable one of skill in the art to practice the disclosed subject matter, the preceding description is intended to be exemplary only. It should not be used to limit the scope of the disclosed subject matter, which should be determined by reference to the following claims.

What is claimed is:

1. A jack stand, comprising:
a base having a collar;
a support arm movable within the collar;
a locking mechanism movable between a first position where the support arm is held in an engaged position and a second position where the support arm is movable; and
a lifting mechanism in communication with the support arm to automatically raise the support arm relative to the collar when the locking mechanism is at the second position.

2. The jack stand of claim 1, wherein the lifting mechanism includes a pneumatic cylinder for driving a ram.

3. The jack stand of claim 1, wherein:
the support arm has a plurality of teeth defining grooves and ridges; and
the locking mechanism interacts with at least one said groove when at the first position, restricting the support arm from moving downwardly.

4. The jack stand of claim 3, wherein the locking mechanism is biased toward the first position with sufficient force such that the support arm does not raise when the locking mechanism interacts with the support arm at a location other than the grooves, the locking mechanism being between the first and second positions when interacting with the support arm at a location other than the grooves.

5. The jack stand of claim 4, wherein the locking mechanism is biased toward the first position with sufficient force such that the support arm does not raise when the locking mechanism is at the first position and interacts with at least one said groove.

6. The jack stand of claim 5, wherein the lifting mechanism is a pneumatic lifting mechanism.

7. The jack stand of claim 6, wherein the locking mechanism is rotatably coupled to the base at an axis of rotation, and wherein a spring is coiled around the axis of rotation and biases the locking mechanism toward the first position.

8. A jack stand, comprising:
a base having a collar;
a support arm movable within the collar, the support arm having a plurality of teeth defining grooves and ridges;
a locking mechanism having a handle and a stopper, the locking mechanism being rotatably coupled to the base at an axis of rotation for movement between a first position where the stopper engages at least one said groove to restrict the support arm from moving downwardly, and a second position where the support arm is movable upwardly and downwardly; and
a lifting mechanism coupled to the base and in communication with the support arm to automatically raise the support arm relative to the collar when the locking mechanism is moved to the second position.

9. The jack stand of claim 8, wherein:
the base defines opposed openings; and
the stopper extends through the opposed openings and interacts with the base at the opposed openings.

10. The jack stand of claim 9, wherein the locking mechanism is biased toward the first position with sufficient force such that the lifting mechanism does not raise the support arm when the stopper interacts with the support arm at a location other than the grooves, the locking mechanism being between the first and second positions when the stopper interacts with the support arm at a location other than the grooves.

11. The jack stand of claim 10, wherein the locking mechanism is biased toward the first position with sufficient force such that the lifting mechanism does not raise the support arm when the locking mechanism is at the first position and the stopper interacts with at least one said groove.

12. The jack stand of claim 11, wherein the lifting mechanism is a pneumatic lifting mechanism.

13. The jack stand of claim 12, wherein a spring is coiled around the axis of rotation and biases the locking mechanism toward the first position.

14. The jack stand of claim 12, wherein a spring biases the locking mechanism toward the first position.
